(19) United States
(12) Patent Application Publication
(10) Pub. No.: US 2024/0330991 A1
(43) Pub. Date: Oct. 3, 2024

(54) Tailored Communications Based On Consumer Information

(71) Applicant: Google LLC, Mountain View, CA (US)

(72) Inventors: Yan Mayster, Aurora, CO (US); Bruce Bahnsen, Boulder, CO (US)

(21) Appl. No.: 18/127,260

(22) Filed: Mar. 28, 2023

(51) Int. Cl. G06Q 30/02; G06Q 30/0601

(52) U.S. Cl. CPC G06Q 30/0281; G06Q 30/0629

(57) ABSTRACT

The technology generally relates to providing tailored communication based on consumer information. The consumer information may include historical purchase information, such as previously purchased items and the respective purchase locations. The consumer information may be used to identify comparable items that may be available at other establishments. The comparable items may be the same as the previously purchased item(s) or share a number of characteristics as the previously purchased item(s). At least one establishment may be identified, wherein such establishment can offer the comparable items from a location that would save travel resources as compared to purchasing the items at the respective previous purchase locations. A tailored communication may be generated and may provide an indication of the establishment, the comparable items, navigational instructions to the identified establishment, an indication of improved travel metrics, etc. The improved travel metrics may be a savings in travel resources.

### BACKGROUND

Consumers typically shop at a plurality of establishments to purchase their preferred items. For example, a consumer may stop at the food store for milk, the drug store for a certain type of hair product, coffee shop for their morning coffee, etc. Driving to multiple establishments to purchase their preferred items is time consuming and expensive in terms of travel resources, such as fuel consumption and carbon emissions.

### BRIEF SUMMARY

The technology generally relates to providing tailored communication based on consumer information. The consumer information may include historical purchase information, such as previously purchased items and the respective purchase locations. The consumer information may be used to identify comparable or complementary items that may be available at other establishments or that can be suggested to other establishments as an item that should be offered. The comparable items may be the same as the previously purchased item(s) or share a number of characteristics of the previously purchased item(s). Complementary items may be items that relate to or are associated with the previously purchased item(s). According to the present disclosure, at least one establishment may be identified wherein such establishment can offer the comparable items from a location that would save travel resources as compared to the respective purchase locations. A tailored communication may be generated based on the consumer information and the identified establishment. In some examples, the tailored communication may provide an indication of the comparable items, navigational instructions to the identified establishment, an indication of improved travel metrics, an affordability metric for a geographic area, etc. The improved travel metrics may, for example, be a savings in travel resources, such as the amount of time or mileage driven, the cost of fuel, reduced carbon emissions, etc. The improved travel metrics may be obtained by purchasing the comparable items from a same location as opposed to having to travel to multiple locations to obtain the items.

One aspect of the technology is directed to a method comprising receiving, by one or more processors, historic consumer information for one or more given consumers including purchase data for a plurality of purchased items and respective purchase locations, at least two of the purchase locations being different, determining, by the one or more processors, whether comparable items to the plurality of purchased items from different purchase locations are available at a given establishment, and generating, by the one or more processors, a tailored communication for the one or more given consumers relative to the given establishment based on determining that the comparable items are available at the given establishment.

The method may further comprise determining, by the one or more processors, first travel metrics associated with the plurality of purchased items at the respective purchase locations, determining, by the one or more processors, second travels metrics associated with purchasing the comparable items at the given establishment, and determining, by the one or more processors, that the second travel metrics are improved as compared to the first travel metrics. Generating the tailored communication may be performed in response to determining that the second travel metrics are improved. The first and second travel metrics may include at least one of a total mileage, a total amount of driving time, a carbon footprint, a driving expense, fuel efficiency, or a total number of stops for a trip.

The method may further comprise identifying, by the one or more processors, the comparable items, where identifying comparable products includes identifying, by the one or more processors, at least one characteristic of a purchased item, and identifying, by the one or more processors, a comparable item having the at least one characteristic of the purchased item. The at least one characteristic may include a type, quality, brand, value, or rating.

Receiving the historic consumer information may include receiving, by the one or more processors, one or more proof of purchase documents. The one or more proof of purchase documents includes a digital receipt or a digital photo of a receipt. The comparable items to the plurality of purchased items may include at least one item being the same as at least one of the plurality of purchased items.

The method may further comprise determining, by the one or more processors, a first estimated cost of living associated with the plurality of purchased items at the respective purchase locations. The method may further comprise providing for output, by the one or more processors, a score representing an aggregated cost of living for a geographic area including the respective purchase locations. The method may further comprise determining, by the one or more processors, a second cost of living associated with purchasing the comparable items at the given establishment, and determining, by the one or more processors, that the second cost of living is improved as compared to the first cost of living, where the tailored communication further includes an indication of an improved cost of living.

Another aspect of the technology is directed to a system including one or more processors, the one or more processors. The one or more processors may be configured to receive historic consumer information for one or more given consumers including purchase data for a plurality of purchased items and respective purchase locations, at least two of the purchase locations being different, determine whether comparable items to the plurality of purchased items from different purchase locations are available at a given establishment, and generate a tailored communication for the one or more given consumers relative to the given establishment based on determining that the comparable items are available at the given establishment.

Yet another aspect of the technology is directed to a computer-readable storage medium, the computer-readable storage medium including instructions that when executed by one or more processors, cause the one or more processors to receive historic consumer information for one or more given consumers including purchase data for a plurality of purchased items and respective purchase locations, at least two of the purchase locations being different, determine whether comparable items to the plurality of purchased items from different purchase locations are available at a given establishment, and generate a tailored communication for the one or more given consumers relative to the given establishment based on determining that the comparable items are available at the given establishment.

Another aspect of the technology is directed to a method of providing navigation instructions for an improved route. The method may include by one or more processors, historic consumer information for one or more given consumers including purchase data for a plurality of purchased items and respective purchase locations, at least two of the purchase locations being different, determining, by the one or more processors, whether comparable items to the plurality of purchased items from different purchase locations are available at a given establishment, determining, by the one or more processors, a first route from a starting location and a first value of one or more travel metrics for the first route, the first route including the respective purchase locations, determining, by the one or more processors, a second route from the starting location and a second value of the one or more travel metrics for the second route, the second route including the given establishment, comparing, by the one or more processors, the first value with the second value to determine which of the first route or the second route represents an improved route having an improved value of the one or more travel metrics, and providing, by the one or more processors, navigation instructions relating to the improved route.

### BRIEF DESCRIPTION OF THE DRAWINGS

FIG. 1 is an example screenshot illustrating an example tailored communication in accordance with aspects of the disclosure.

FIGS. 2A-2B are pictorial diagrams of example consumer information in accordance with aspects of the disclosure.

FIG. 3 is a pictorial diagram identifying comparable items based on consumer information in accordance with aspects of the disclosure.

FIG. 4A is an example map identifying current and suggested establishments in accordance with aspects of the disclosure.

FIG. 4B illustrates a pictorial diagram illustrating another example tailored communication in accordance with one embodiment.

FIG. 5 is a pictorial diagram illustrating how an example tailored communication is generated in accordance with aspects of the disclosure.

FIG. 6A is a pictorial diagram illustrating cost of living scores for geographic regions in accordance with aspects of the disclosure.

FIG. 6B is a pictorial diagram of a heat map illustrating cost of living for geographic regions in accordance with aspects of the disclosure.

FIG. 6C is a pictorial diagram illustrating an example cost of living meter for geographic regions in accordance with aspects of the disclosure.

FIG. 7A is a block diagram of an example system in accordance with aspects of the disclosure.

FIG. 7B is a pictorial diagram of the example system of FIG. 7A.

FIG. 8 is a flow diagram of an example method for generating a tailored communication in accordance with aspects of the disclosure.

FIG. 9 is a flow diagram of an example method for providing navigation instructions for an improved route in accordance with aspects of the disclosure.

### DETAILED DESCRIPTION

The technology is generally directed to identifying regional affordability and generating recommendations for an objectively improved resource consumption based on specific historical consumer information. The consumer information may include historical and predicted location and purchasing habits. The consumer information may include information relating to the current location of the user, potential future locations of the user, past items purchased by the user, the purchase location of the items, etc. Items may include, for example, products or services. Based on the consumer information, comparable and/or complementary items to a user's previously purchased items may be identified. An establishment, such as a business or merchant, that can offer the comparable items from a location that would improve travel metrics as compared to the respective purchase locations may be identified. For example, the identified establishment may have a plurality of previously purchased items available for purchase. By purchasing the comparable and/or complementary items from the establishment, the travel metrics, such as travel time, travel expenses, carbon footprint, etc. may be improved. For example, purchasing the comparable and/or complementary items from the identified establishment may decrease travel time as the user travels to one location, as compared to a plurality of establishments, decrease travel costs by using less fuel, decrease carbon footprint by driving less mileage and/or for less time, etc.

A tailored communication may be generated identifying the establishment. The tailored communication may be transmitted to the user. According to some examples, the tailored communication may provide an indication that purchasing the items at the identified establishment may reduce travel resources and/or improve travel metrics. The travel metrics may include, for example, the number of stops, time, mileage, etc. for a shipping trip. According to some examples, the improved value of the travel metrics may be determined by comparing a value of the travel metrics for a navigational route for the user to travel to the previous purchase locations to the value of the travel metrics for a navigational route for the user to travel to the identified establishment. In some examples, the navigational route for the user to travel to the identified establishment may be the tailored communication and/or included with the tailored communication.

By identifying at least one establishment that has comparable items available corresponding to user's previously purchased items, travel resources may be reduced. For example, a user purchasing the comparable items at the identified establishment as compared to the plurality of previous purchase locations may reduce the number of stores a user has to travel to purchase the items. Additionally or alternatively, the identified establishment may not only offer the comparable items, but the identified establishment may improve a value of travel metrics to travel to the identified establishment as compared to the plurality of previous purchase locations. An improvement in travel metrics may include, for example, decreasing the total mileage traveled to purchase the items, decreasing transportation costs associated with traveling to purchase the items, decreasing the carbon footprint associated with traveling to purchase the items, increasing fuel efficiency, decreasing the number of stops, etc.

According to some examples, identifying the one or more establishments may include generating a recommendation to the one or more establishments to offer particular products or services. For example, the recommendation can suggest that the establishment should stock a particular product, complementary product, or a comparable product, offer a particular service, etc. based on the historic consumer information. In this regard, the establishment can potentially adapt to expand its offerings to meet the shopping needs of the consumer based on the consumer information. For example, the establishment can provide an update or other indication when it begins offering the particular product or comparable product or service, and may then be included for consideration as one of the identified one or more establishments.

Providing a tailored communication indicating the identified one or more establishments as a potential alternative source for the consumer's purchases allows the consumer to make a well-informed decision to reduce their travel metrics. This may conserve resources by reducing fuel and/or electricity units, decrease travel expenses, time of travel, distance of travel, etc. for the user.

According to some examples, the tailored communication may identify regional affordability. Regional affordability may include, for example, a cost of living for a given geographic area. The cost of living may provide an indication of how much it would cost to live in the geographic area as compared to another geographic area. The geographic area may be a neighborhood, city, county, state, etc. The consumer information for users within the geographic area may be aggregated to determine the cost of living for that area. The users within the geographic area may be determined based on their identified starting location being within the geographic area. The cost of living for the geographic area may be determined by aggregating historical purchase information for the users within the geographic area. The cost of living may be output as a score or overlay on a map, indicated within the tailored communication, or otherwise provided as output.

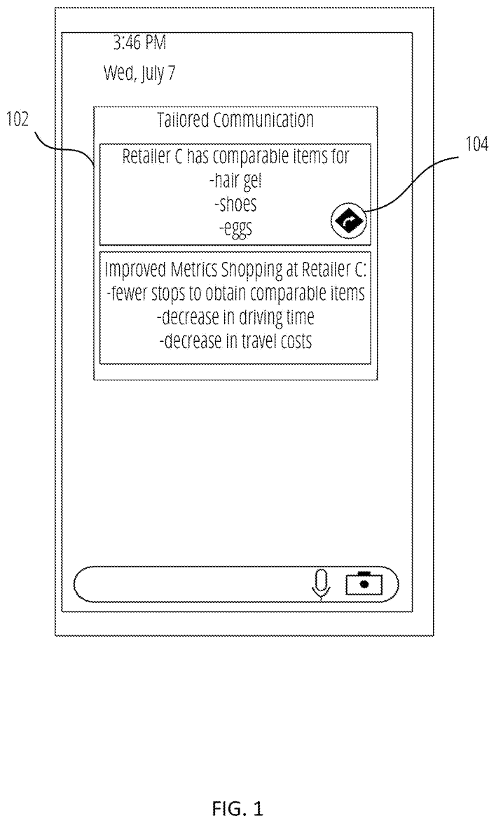

FIG. 1 is an example screenshot illustrating an example tailored communication. The tailored communication 102 may include an indication of a merchant, establishment, shopping center, etc. in which comparable and/or complementary items to those previously purchased by the user are available for purchase. The comparable items may be the same or substantially similar to those previously purchased by the user. The merchant may be identified based on the availability of having comparable items available for purchase in a single location, rather than the user having to make multiple stops to purchase the items. According to some examples, the merchant may be identified based on its offering of complementary products available for purchase in a single location. Complementary products may be, for example, one or more products associated with a previous purchase. For example, if a user previously purchased a bicycle, complementary products may include a helmet, tire pump, or the like. The single location may be, for example, a single merchant, a single shopping center, etc. The comparable and/or complementary items and, therefore, the identified merchant may be determined based on the user's consumer information.

The tailored communication may be generated in response to determining that the identified merchant can offer the comparable items for purchase at one location, rather than the user having to travel to a plurality of locations to purchase the same items. By identifying a merchant that can offer the comparable items in one location, e.g., a single store or several stores within a close geographic distance, such as a shopping center, travel resources may be conserved. For example, a user traveling to one location to purchase the comparable items rather than traveling to a plurality of stores may save fuel, reduce the user's carbon footprint, decrease the driving time and/or mileage, etc.

Consumer information may include location information and information related to previous purchases for respective users. The users may, additionally or alternatively, be referred to as consumers, customers, etc. The location information may include, for example, a current location of the user, a location of a merchant frequented by the user, a location of a previous purchase, a purchase pick-up location, etc. Information related to previous purchases may include, for example, an item purchased by the user, a value associated with the item, information related to the merchant offering the item, etc. According to some examples, the consumer information may include a timestamp, indicating the day of the week, time of day, etc. of the purchase. The time stamp may be used to identify patterns in a consumer's purchase habits.

According to some examples, an application may be used to collect, store, process, etc. consumer information. The user may have a profile associated with the application. The application may include an option to connect a digital wallet to the user profile. The digital wallet may be used to identify previous purchases made with funds associated with the digital wallet.

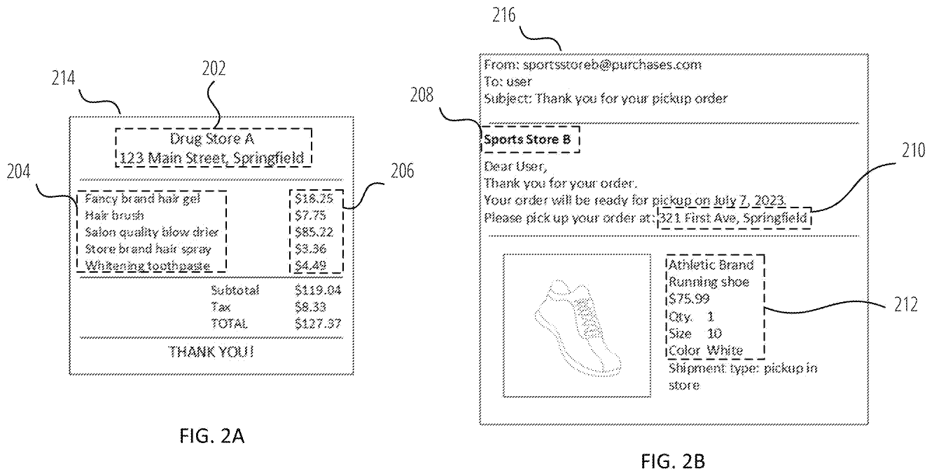

According to some examples, the application may include an option to upload documents, photos, videos, digital media, etc. documenting expenditures. For example, a user may scan or take a picture of a physical receipt, such as receipt 214 shown in FIG. 2A. The application may parse the captured text to identify consumer information, such as the merchant 202, the category, the items purchased 204, the respective value of the items 206, the purchase location 202, the pick-up location if the purchase was made online or via phone, etc.

As shown in FIG. 2A, the application may parse the captured text of the receipt 214 to identify merchant information 202, such as the name of the merchant, the location of the merchant, etc., the category of the items, the specific items 204, the value of the items 206, characteristics of the items, etc. The category of the items 204 may be, beauty products, health care, etc. According to some examples, the items 204 may fall into one or more categories or sub-categories. For example, whitening toothpaste may be categorized under health care, but may, additionally or alternatively, be categorized under dental care.

In some examples, the user may upload a digital receipt from an online purchase, such as receipt 216 shown in FIG. 2B. The application may parse the digital receipt to identify the merchant 208, the purchased item 212, whether the item was delivered or was picked-up by the user 212, the pick-up location 210, etc.

In some examples, the digital wallet may identify items on digital receipts, the value of the items, the merchant of the transaction, etc. According to some examples, the digital wallet may identify a category of the items rather than the specific items. For example, the digital wallet may determine the user purchased $350 of groceries at the food store with funds associated with the digital wallet. The digital wallet may identify the category as groceries and the value as $350. In some examples, the digital wallet may identify individual items and their respective value, such as item: whole milk and value: $4.29.

As shown in FIG. 2B, the digital wallet may identify items on digital receipt 216. For example, the digital wallet may determine the user purchased $75.99 of sporting goods from merchant 208, e.g., “Sports Store B.” The digital wallet may identify the category as sporting goods and the value as $75.99. In some examples, the digital wallet may identify item characteristics 212, such as the brand: “Athletic Brand”, item: running shoe, value: $75.99, size, color, rating, etc.

Consumer information may be used after the user provides authorization for the system to access or receive consumer information. For example, the user may provide authorization to an application or the system to access one or more databases in the memory of the user's device, vehicle, remote servers, etc. According to some examples, when authorized by the user, location sensors on the user device, vehicle, etc. may provide location information indicating a current location of the user, a merchant location of previous purchases, etc.

The consumer information may be used to identify an establishment that has items available that are comparable to a user's previously purchased items and would save travel resources when traveling to purchase the comparable items from the identified establishment as compared to the respective purchase locations. The user's previously purchased items may have been purchased at two or more different locations, such as Drug Store A and Sports Store B. The identified merchant or establishment, therefore, may improve travel metrics for the user. For example, the identified establishment may reduce the number of locations a user has to visit to purchase their items, decrease travel expenses by requiring less fuel to travel to the establishment, reduce carbon emissions, increase fuel efficiency, etc. The improved travel metrics may be determined based on a navigation route to the identified establishment from a starting location, such as the user's home address, as compared to a route including the respective purchase locations of the plurality of establishments starting from the same starting location.

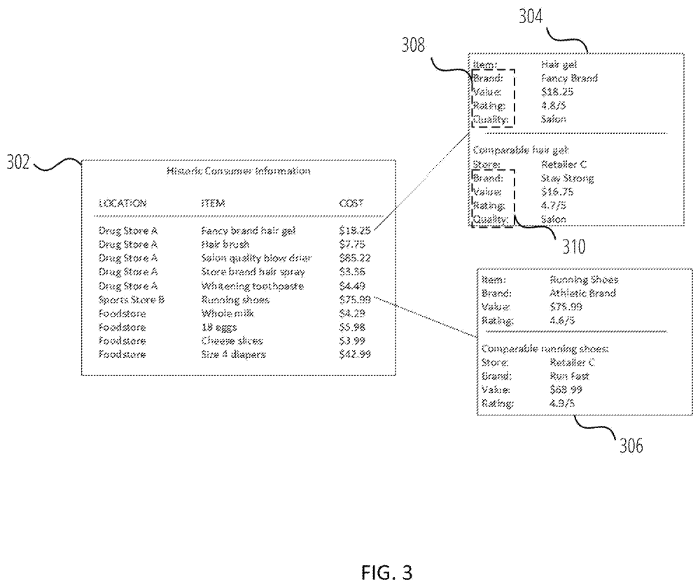

To identify the given establishment, historic consumer information may be used to identify purchase data for previously purchased items as well as the respective purchase locations. FIG. 3 illustrates comparable items 304, 306 identified based on historic consumer information 302. As shown, the historic consumer information 302 may indicate that the user previously purchased hair gel from Drug Store A, shoes from Sports Store B, groceries from “Foodstore.” An establishment may be identified that carries items comparable to hair gel from Drug Store A and shoes from Sports Store B and can save travel resources as compared to traveling to Drug Store A and Sports Store B to purchase the items. The comparable items 304, 306 may be items that are similar or equivalent to the previously purchased items. As such, at least one comparable item may be the same as a previously purchased item, or indeed all comparable items may be the same as the previously purchased items.

To identify comparable items 304, 306, the characteristics 308 of the previously purchased item, such as type, quality, brand, value, rating, etc., may be determined. For example, if the previously purchased item is hair gel, the characteristics 308, such as the brand, value, quality, rating, etc., of the previously purchased hair gel may be determined. The characteristics 308 of the previously purchased hair gel may include, for example, the brand: Fancy Brand, value: $18.25, rating: 4.8/5, quality: salon, etc. The characteristics 308 may be determined based on the historic consumer information 302, information related to items stored in a database, user provided information, publicly available information such as item information and characteristics available on a merchant's website, etc.

One or more items comparable to the previously purchased hair gel may be identified. The comparable item 304 may have at least one similar characteristic to the previously purchased hair gel. According to some examples, the comparable item 304 may share some of the characteristics of the previously purchased item, such as a similar rating, quality, etc., but may have a value less than the previously purchased item. In such an example, the comparable item may provide the customer with a similar, or comparable, experience but for an equal or lesser value. As shown, the comparable hair gel 304 is a different brand, has a lesser value, a substantially similar rating, and the same quality as the previously purchased hair gel. An establishment having the comparable item may be identified. As shown, Retailer C has the comparable hair gel 304 available. According to some examples, a plurality of comparable items may be identified. Additionally, or alternatively, a plurality of establishments may be identified as having the comparable item available.

As another example, one or more items comparable to the previously purchased running shoes may be identified. The comparable running shoes 308 may have similar characteristics to the previously purchased hair gel. For example, the comparable running shoes 308 may be a different brand, “Run Fast,” as compared to the previously purchased brand, “Athletic Brand,” but may have a better rating and a lower value as compared to the previously purchased running shoes. Retailer C may be identified as having the comparable running shoes 306 available. However, additional establishments may be identified and/or additional comparable items and respective establishments may be identified.

One or more complementary items to the previously purchased items, such as hair gel, may be identified. The complementary products may be a product that is related to or associated with the previously purchased product. Using hair gel as an example of a previously purchased product, complementary products may include, for example, hair brushes, styling tools, such as a blow drier, hair spray, bobby pins, etc. To identify complimentary items, the characteristics 308 of the previously purchased item, such as type, quality, brand, value, rating, etc., may be determined. The characteristics 308 of the previously purchased item may be correlated to characteristics of available items to identify a complementary item. For example, the complementary item may have a similar rating, quality, etc. as the previously purchased item.

Once the comparable items 304, 306 and/or complementary items are identified, one or more establishments that have the comparable and/or complementary items as available for purchase may be identified. The establishments may be an establishment having a physical location, such as a physical store or a shopping center, or an online establishment. For example, Retailer C may be identified as having both comparable hair gel 304 and running shoes 306, e.g., previous user purchases, available for purchase. Instead of going to Drug Store A and Sports Store B, a recommendation may be provided to the user to, instead, visit Retailer C to purchase comparable items 304, 306. According to some examples, instead of going to Drug Store A and Sports Store B, a recommendation may be provided to the user to, instead, visit an online retailer to purchase comparable and/or complementary items. This may reduce the number of stores the user has to travel to in order to purchase items. According to some examples, when identifying the establishment that can offer the comparable items, the system may also identify an establishment that can also save travel resources. For example, by identifying Retailer C as having the comparable items, Retailer C may save travel resources and/or improve travel metrics as compared to the user having to travel to Drug Store A and Sports Store B.

According to some examples, a shopping center having establishments with the comparable items 304, 306 may be identified. For example, a shopping center may have a plurality of establishments. The establishments within the shopping center may be identified as having comparable items available. The shopping center, and the respective establishments, may be identified instead of a single establishment having the comparable items 304, 306. While the user may visit a plurality of stores within the shopping center, the user may only have to travel to a single shopping center to purchase the comparable items as compared to making multiple stops to purchase the items. As such, the shopping center may be regarded as a single establishment formed of a plurality of sub-establishments sharing a similar location. Travel to the shopping center may thus only require one “stop” along a route. For example, Shopping Center S may include Sports Store M and a Big Box Store Z. Sports Store M may offer items comparable to Sports Store B and Big Box Store Z may offer items comparable to Drug Storage A and/or Sports Store B. Shopping Center S may, therefore, offer the comparable items from a location that would save travel resources and/or improve travel metrics as compared to traveling to the respective purchase locations, e.g., Drug Store A and Sports Store B. Similarly, a retail park may also be regarded as a single establishment formed of a plurality of sub-establishments sharing a similar location, such that travel to the plurality of sub-establishments only requires one stop along a route. Indeed, any collection of establishments within a threshold distance from each other or from a central geographical point may be regarded as a single establishment formed of a plurality of sub-establishments. The central point of the plurality of sub-establishment may be, for example, the center of a line between two sub-establishments, the center of a polygon between more than two sub-establishments, a parking area most proximal to the sub-establishments, or a transit station most proximal to the sub-establishments. Navigation to the plurality of sub-establishments may comprise navigation to the central point.

In some examples, an establishment may, additionally or alternatively, be identified based on timestamp information associated with previous purchases. For example, if the user typically purchases a coffee Sunday morning at a coffee shop and then travels to another establishment to purchase groceries, an establishment or shopping center having both a coffee shop and comparable groceries may be identified.

After identifying an establishment that has the comparable and/or complementary items available and would save travel resources, a tailored communication, such as the tailored communication 102 shown in FIG. 1, may be generated. The saved travel resources may be determined based on a comparison of a value of the travel metrics for a navigation route to the previous purchase locations as compared to a navigation route to the identified establishment, with both routes starting from the same starting location. The tailored communication 102 may be transmitted to the users for which the establishment has items comparable to the users' previously purchased items that were purchased at more than one location and which would save travel resources. This may alert the user to an alternative establishment that provides comparable items to those previously purchased in one location, rather than having to travel to multiple establishments to purchase the items. According to some examples, reducing the number of establishments a user has to visit, or the number of stops a user has to make, to obtain the same items previously purchased at a plurality of locations may improve metrics, such as travel metrics.

The establishment may be identified using an artificial intelligence engine or a machine learning model. For example, the artificial intelligence engine may receive as input various information related to the user's prior purchases and the user's interests, intents, etc. Based on such various information, the artificial intelligence engine may predict an establishment, such as a physical or online retailer, to supply products to the user with greater efficiency as compared to the user's prior purchase habits. The machine learning model can be generated and/or trained using feature data and signal data. For example, the feature or combination of features can be a predictor or independent variable, and the signal can be a dependent variable or criterion variable that can change as the features are varied. The features may be, for example, historical consumer information, and the signals may be, for example, establishments that would improve travel metrics for the consumer. In some examples, the machine learning model can estimate or determine a conditional expectation of a dependent variable given the independent variables, such as an average value of the improvement in travel metrics when the independent variables, e.g., the historical consumer information, is fixed.

According to some examples, the machine learning model may receive consumer information as first training data and product information from establishments as training data. The product information from establishments may include an inventory identifying what products the establishment offered, information related to the products, such as the brand, quality, rating, etc., the price the establishment if offering the products, etc. The first and second training data may be associated with labels. The labels may include, for example, product labels, providing an indication of the type, quality, brand, value, rating, etc. of the product. The first and second training data may be associated with the labels with or without human review or intervention. In some examples, the first and second training data may be automatically associated with a product label. In some examples, the first and second training data may already include associated labels at the time of collection.

The model may be trained using the first and second training data and associated labels to generate a prediction of one or more establishments and products, such that the user visiting the establishments to obtain the products would improve travel metrics over the user's historical routine, and therefore increase efficiency.

The model can repeat the training multiple times, until meeting one or more stopping criteria. The stopping criteria can include, for example, a maximum number of training iterations and/or, for supervised learning or semi-supervised learning, iterations of backpropagation, gradient descent, and model parameter update. The stopping criteria can additionally or alternatively define a minimum improvement between training iterations. For semi-supervised training, an example can be a relative or absolute reduction in the computed error between output predicted by the model and corresponding ground-truth labels on training data reserved for validation and/or testing. For unsupervised learning, an example loss function can be least squares.

Referring back to FIG. 1, the tailored communication 102 may be generated and transmitted to the user. The tailored communication 102 may identify the establishment, Retailer C, which was identified as having available items comparable to those that were previously purchased by a user at a plurality of establishments and/or would result in improved travel metrics. For example, the tailored communication 102 may indicate that Retailer C has comparable hair gel, shoes, and eggs as those previously purchased by the user.

The tailored communication 102 may, additionally or alternatively, include an indication of improved metrics if the user were to shop at Retailer C instead of the plurality of establishments. The improved metrics may be, for example, improved travel metrics. Travel metrics may include, for example, number of stops, total driving time, total driving distance, travel costs or expenses associated with traveling to the merchants, carbon footprint, etc. As shown, if the user were to shop for the comparable items at Retailer C, rather than the plurality of other merchants, the user would make fewer stops, decrease their driving time, and decrease their travel costs.

In some examples, as shown in FIG. 1, the tailored communication 102 may include an input 104 which, when selected, provides navigational directions to the identified establishment, e.g., Retailer C. The navigational directions may be a route to the identified establishment having improved travel metrics as compared to a route for the previously visited establishments. According to some examples, the tailored communication 102 may include navigational directions for the route having improved travel metrics.

The travel metrics may include, for example, a total mileage, total amount of driving time, a carbon footprint, a driving expense, total number of stops for a trip, etc. Improving travel metrics for the user may be, for example, reducing the number of establishments the user has to visit to purchase items. According to some examples, improving travel metrics may include decreasing the total amount of driving time, mileage driven, or carbon footprint when purchasing items.

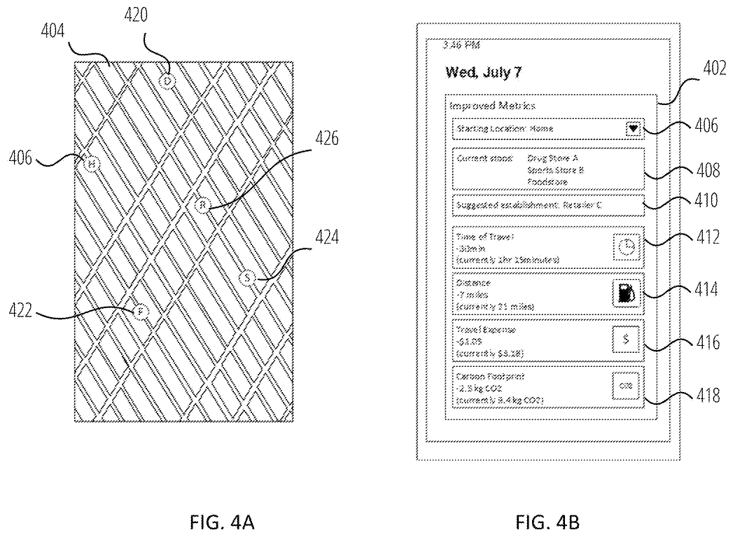

FIG. 4A illustrates example location information determined based on the user's consumer information. The location information may be based on location information determined from previous purchases, such as the establishment name and location of a receipt, a navigational system, a mapping application, etc. Location information may be, for example, data collected by a device having a location sensor, such as a global positioning system (GPS), which illustrates the establishments the user has traveled to. In some examples, location information may include destinations, or establishments, identified in emails, calendar appointments, etc. that the user has allowed the system to access.

Location information may be used after the user provides authorization for the system to access or receive location information. For example, the user may provide authorization to an application or the system to access one or more databases in the memory of the user's device, vehicle, remote server, etc. According to some examples, location information may be used after the user provides authorization for the system to access or receive consumer information.

The locations identified by the location information may correspond to establishments where the user has previously purchased times. The location information may be used to identify previously visited establishments, or shopping centers, starting location for the shopping trips, etc.

As shown in FIG. 4A, the system may have identified the user's starting location 406, establishments where the user previously purchased items, such as Drug Store A 420, Foodstore 422, and Sports Store B 424, and establishments that may improve travel metrics, such as Retailer C 426.

FIG. 4B illustrates an example tailored communication 402 providing improved metrics. The metrics may be travel metrics, such as the time of travel 412, distance traveled 414, travel expenses 416, carbon footprint 418, etc. The improved metrics may be determined based on the starting location 406, the current stops 408, and the suggested establishment 410. The starting location 406 may be based on location information indicating the user leaves for the establishments from the same or similar location each time. According to some examples, the starting location 406 may be input by the user.

According to some examples, the improvement in travel metrics may be based on a comparison of the travel metrics for the user to travel to their current stops 408 to the travel metrics for the user to travel to the suggested establishment 410. For example, based on the starting location 406 and current stops 408, the time of travel 412, distance traveled 414, travel expenses 416, and carbon footprint 418 may be determined. In one example, the time of travel 412 may be determined based on the time it takes to travel from the starting location 406 to each of the current stops 408 before returning to the starting location 406 to complete the trip. The distance traveled 414 may, similarly, be determined based on the distance between the starting location 406, each of the current stops 408, and then the return trip to the starting location 406.

The travel expenses 416 may be determined based on the efficiency of the vehicle, the distance traveled 414, and the cost for fuel, such as the cost of gas for a vehicle with an internal combustion engine or the cost of electricity for an electric vehicle. For example, if the vehicle used to make the shopping trip gets approximately 22 miles per gallon, the distance traveled 414 was 21 miles, and the cost of gas is $3.33, the travel expense 416 may be determined using the following equation:

$$travel expense = ( \frac{cost of fuel}{fuel efficíency} ) \times distance traveled$$

In the example given, the travel expense would be equal to

$$( \frac{\$ 3.33}{22} ) \times 21 = \$3 \text{.18} .$$

According to some examples, when determining the travel metrics, the system may request information regarding the user's vehicle, such as the make and model of the vehicle. The system may use the information regarding the user's vehicle to determine the fuel efficiency of the user's vehicle. In yet another example, if the system is integrated into the vehicle's onboard navigational system, after the user authorizes the system access to the vehicle's information, such as the make and model of the vehicle, the vehicles estimated fuel efficiency, etc., the system may use the vehicle information when determining travel metrics.

The travel metrics may be determined for the suggested establishment 410. The travel metrics for the suggested establishment 410 may be determined in substantially the same way but, rather than determining the time of travel 412, distance traveled 414, travel expenses 416, and carbon footprint 418 for traveling to the current stops 408, the travel metrics may be determined for traveling from the starting location 406 to the suggested establishment 410. In the example shown, traveling to Retailer C 426 from starting location 406, the time of travel 412 is 30 minutes, the distance traveled 414 is 7 miles, the travel expenses 416 is $1.05, and the carbon footprint 418 is 2.3 kg CO2. The travel metrics for traveling to Retailer C 426 instead of the current stops 408 are, therefore, improved as the time of travel 412 has decreased, the distance traveled 414 has decreased, the travel expenses 416 have decreased, and the carbon footprint 418 has decreased.

The tailored communication 402 may indicate the current travel metrics for the user traveling to the current stops 408 as well as the travel metrics if the user were to travel to the suggested establishment 410 instead of the current stops. The comparison may be used to show the effect of visiting a single establishment, or shopping location, rather than multiple establishments to purchase the same, comparable, or complementary items. According to some examples, the comparison may be used to show the effect of purchasing the same, comparable, or complementary products from an online establishment, rather than multiple physical establishments. For example, the tailored communication 402 may recommend that purchasing the products online would save resources, such as by comparing a fuel level that would be consumed by the user in visiting physical establishments with a fuel level that would be consumed by a shipping or delivery service in delivering the products from an online retailer. This may allow the user to make a well-informed and objective decision to reduce their travel metrics while still being able to purchase the same or comparable items they have previously purchased. In some examples, the current travel metrics may be used to determine alternative establishments that would meet or are below the threshold travel metrics. This may conserve resources by reducing fuel and/or electricity usage. In some examples, the suggested establishments may decrease travel expenses, time of travel, distance of travel, etc. for the user. In some examples, an improved travel metric may be an increase in fuel efficiency.

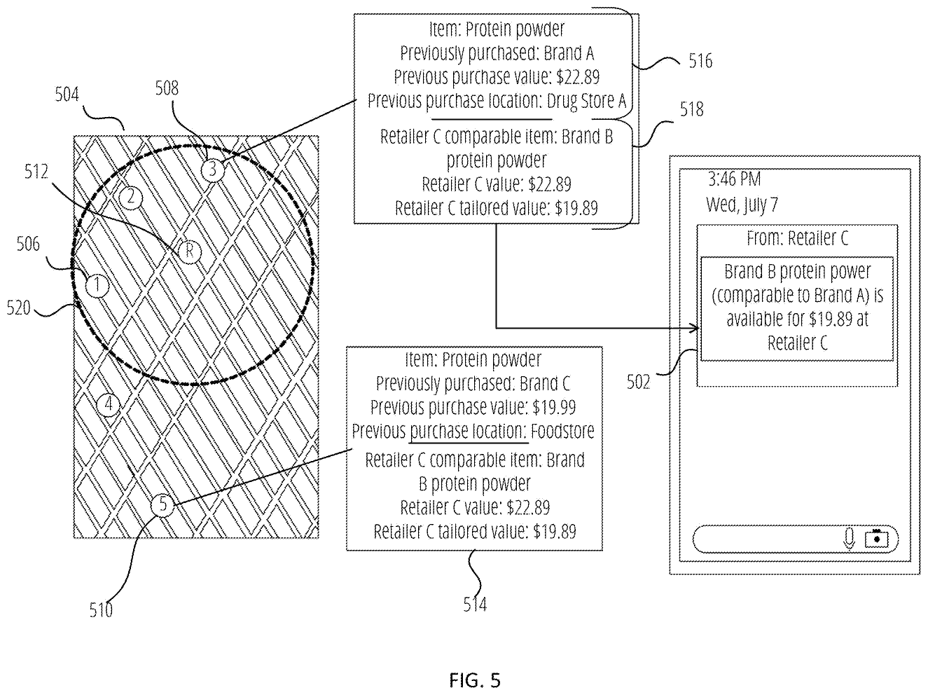

FIG. 5 illustrates an example flow diagram of using the consumer information to identify tailored communications to offer to potential customers. The tailored communications 502 may include targeted advertisements or promotions. The tailored communications 502 may be used by merchants to attract new customers to their business.

To identify the tailored communications 502 and the potential customers to transmit the tailored communication 502 to, consumer information may be used to identify comparable, complimentary, or identical items being offered by a given merchant. For example, the consumer information 516 may indicate that a customer, customer “3” 508, located within a given threshold 520 of the establishment, Retailer C 512, has previously purchased “Brand A” protein powder. Retailer C 512 may stock, or offer, a comparable item 518, such as “Brand B” protein powder. Tailored communications for “Brand B” protein powder may be identified. A tailored value associated with the tailored communication may, additionally, be identified. The tailored value may be the value of the item, e.g., “Brand B” protein powder, based on the tailored communication.

The tailored value of the product may be compared to the previous value of the item. For example, the tailored value of the item, “Brand B”protein powder” may be compared to the value of “Brand A” protein powder. The value of “Brand A” protein powder may be determined based on the previous purchase information associated with the consumer information. Customers for which the tailored value of “Brand B” is less than the previous value of “Brand A” may be identified. The tailored communication 502 may be transmitted to the identified customers.

According to some examples, the tailored communication may be transmitted to customers for which the tailored value is less than the previous value based on the previous purchase information. Additionally, or alternatively, the tailored communication may be transmitted to customers who have not yet frequented the merchant offering the tailored communication. In some examples, the tailored communication may be transmitted to customers within a threshold distance 520 from the merchant. For example, the tailored communication may be transmitted to any, some, or all potential customers within a 20-mile radius of the merchant. As shown in FIG. 5, even though the tailored value for the comparable item is less than the previous purchase value for customer “5” 510, customer “5” is outside the threshold distance 520 from Retailer C 512. As customer “5” is outside the threshold 520, the tailored communication 502 may not be transmitted to the customer.

Tailored communications may be transmitted to potential customers after verifying that the customers have authorized consumer information sharing. For example, after verifying that the customers have authorized consumer information sharing, select customers that can benefit from the tailored communication may be identified. In such an example, the select customers may benefit from the tailored communication when the tailored value of the same or comparable item is less than a previous purchase value of the item. Additionally, or alternatively, select customers within a threshold distance of the merchant location may be identified. In yet another example, after verifying that the customers have authorized consumer information sharing, potential new customers of the merchant may be identified based on a comparison of the customers' previous purchases and the items offered by the merchant. The tailored communication may be transmitted to the select customers that have authorized consumer information sharing.

By determining select users to whom the tailored communications should be transmitting, the system beneficially determines potential and/or new customers for a given in a computationally efficient and power efficient way. For example, by limiting communications to those tailored to the selected users, the system conserves network resources such as bandwidth, memory, power, and other resources that would otherwise be used to send communications to a broader set of recipients.

Further, identifying select customers to receive the tailored communications provides environmental advantages. For example, the selected customers may be customers that historically traveled to multiple locations to obtain the purchased items. By alerting the selected customers that such items are available at one merchant in one location, travel resources, such as fuel and other resources that would otherwise be consumed in obtaining the items from multiple locations, can be saved.

The tailored communication to offer to potential customers may be identified using a machine learning model. The machine learning model maybe trained to predict potential customers for a given establishment. The machine learning model may receive consumer information as first training data and product information from establishments as second training data. The product information from establishments may include an inventory identifying what products the establishment offered, information related to the products, such as the brand, quality, rating, etc., the price the establishment is offering the products, etc. The first and second training data may be associated with labels. The labels may include, for example, product labels, providing an indication of the type, quality, brand, value, rating, etc. of the product. The first and second training data may be associated with the labels with or without human review or intervention. In some examples, the first and second training data may be automatically associated with a product label. In some examples, the first and second training data may already include associated labels at the time of collection.

The model may be trained using the training data and associated labels to provide a prediction of potential customers. The predicted potential customers may be customers who can improve their travel metrics by shopping at the establishment and/or decrease their spending by shopping at the establishment.

The model can repeat the training multiple times, until meeting one or more stopping criteria. The stopping criteria can include, for example, a maximum number of training iterations and/or, for supervised learning or semi-supervised learning, iterations of backpropagation, gradient descent, and model parameter update. The stopping criteria can additionally or alternatively define a minimum improvement between training iterations. For semi-supervised training, an example can be a relative or absolute reduction in the computed error between output predicted by the model and corresponding ground-truth labels on training data reserved for validation and/or testing. For unsupervised learning, an example loss function can be least squares.

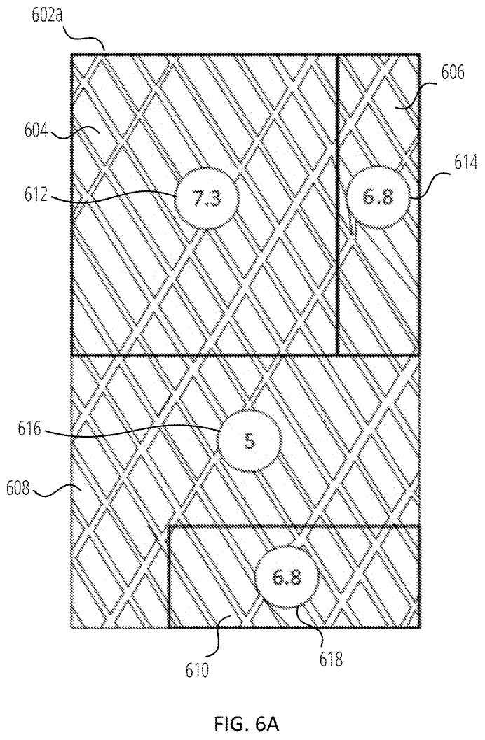

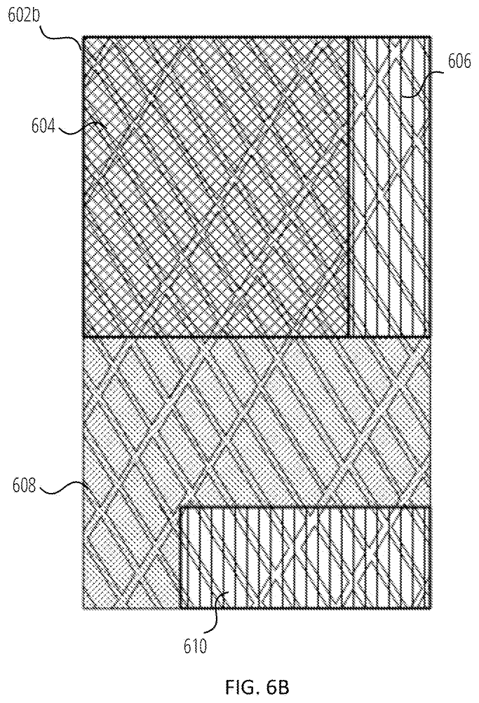

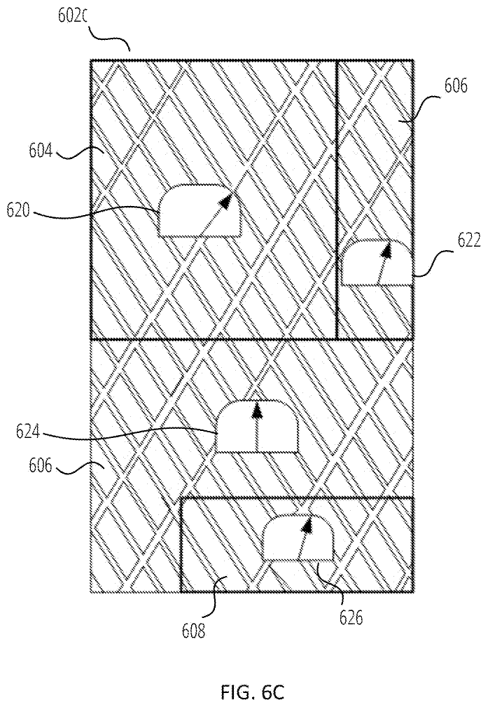

FIGS. 6A-6C illustrate example maps indicating regional affordability. Regional affordability may include, for example, a cost of living for a given geographic area. Consumer information may be used to determine the cost of living for an individual and/or the given geographic area, such as a neighborhood, city, county, state, etc. For example, the cost of living for an individual may be determined as an aggregate of the historical purchase information. According to some examples, the cost of living for a geographic area may be determined by aggregating the consumer information for user's within the geographic area. User's within the geographic region may be identified based on a starting location, such as the starting location for navigation routes to the previous purchase locations and/or the starting location used to compare the value of travel metrics. According to some locations, the starting location may be the user's home or work address, or any other address that is identified as a frequent starting address for navigational routes for the user. The cost of living for a given area may be output as an overlay on a map.

According to some examples, the system may identify a plurality of areas in which the average cost of living has been determined. The areas may include area 604, area 606, area 608, and area 610. The system may determine the average cost of living for those areas 604, 606, 608, 610 based on consumer information for user's having an existing starting address in that area 604, 606, 608, 610. While areas 604, 606, 608, 610 are shown as rectangular, areas area 604, 606, 608, 610 may have an arbitrary shape or may have a shape corresponding to the designation of a given neighborhood, town, county, state, etc. Accordingly, the shape of areas 604, 606, 608, 610 being rectangular is merely one example and is not intended to be limiting.

The system may determine the average cost of living for a given area 604, 606, 608, 610 based on consumer information and location information of user's located in that area. For example, the system may determine users in areas 604, 606, 608, 610 who have authorized location sharing and consumer information sharing. The system may identify historical purchase information for those respective users. Based on the historical purchase information, the system may aggregate the historical purchase information to determine an average, or median, cost of living for a given area 604, 606, 608, 610. According to some examples, certain data, such as location information or consumer information, may be treated in one or more ways before it is stored or used, so that personally identifiable information is removed.

In response to a selection of an area 604, 606, 608, 610, the system may output the average cost of living for the selected area 604, 606, 608, 610. The output may include an indication of the average cost of living as a pop-up, score, overlay, etc. The indication may include the average cost of living for the respective area 604, 606, 608, 610.

As shown in FIG. 6A, the system may output a score 612, 614, 616, 618 for a given area on a map 602a. According to some examples, a high score may indicate a high cost of living whereas a low score may indicate a low cost of living. As shown, area 604 has a score 612 of “7.3” whereas area 608 has a score 616 of “5.” The average cost of living for area 604 is higher than the average cost of living for area 608. While FIG. 6A illustrates a high score corresponding to a higher cost of a living, according to some examples a low score may correspond to a higher cost of living. Further, while the scores 612, 614, 616, 618 are shown as numerical values, the scores may be a meter, such as in FIG. 6C., stars, sliding scales, etc. According to some examples, the system may include an option for the user to switch the information from average cost of living to median cost of living. In yet another example, the system may include options to change the period of time from week to day, month, two weeks, three months, year, etc.

FIG. 6B illustrates an example heat map overlay providing an indication of the average or median cost of living for a given area 604, 606, 608, 610. The score for a given area 604, 606, 608, 610 may correspond to a given pattern or overlay on map 602b. For example, the cross-hatched pattern overlaid on area 604 may correspond to a score of 7.3, whereas the dot pattern overlaid on area 608 may correspond to a score of 5. According to some examples, the same pattern may be overlaid on the map but the color and/or density of the pattern may indicate the corresponding score. For example, the overlay may be a coded map, a heat map, etc. with a color corresponding to a specific range of the cost of living.

According to some examples, a predicted cost of living may be determined based on the identification of an establishment that have comparable products available. For example, the predicted cost of living may be based on the value of the comparable products at the establishment, rather than the historical purchase value. In some examples, the predicted cost of living may include predicted savings based on improved travel metrics for traveling to the establishment instead of the multiple previous purchase locations. The cost of living based on historical purchase information may be compared with the predicted cost of living based on the comparable products. According to some examples, the tailored communication transmitted in response to identifying the establishment may include an indication of the improved cost of living.

In another example, the consumer information may be used to determine an estimated cost of living if the customer were to change locations, such as by moving from a first location to a second location. For example, based on the previous purchases of the user, the system may determine the expected expenditure for the user if the user were to move to a different location. In one example, the consumer information may be generated based on the user's current location, “Town A.” The user may be seeking to relocate to another location, such as “Town B.” The user's consumer information may be used to generate predicted consumer information for making comparable or identical purchases in Town B based on the user's previous purchases in or around Town A. For example, based on the items identified in the user's consumer information, comparable or identical items available in or around Town B may be identified. The value associated with the comparable or identical items may be aggregated to correspond to the consumer information, user profile, etc. generated based on previous purchases in Town A. The aggregated value of items from Town B may identify a predicted cost of living, expected expenditures, etc. for the user if they were to relocate Town B.

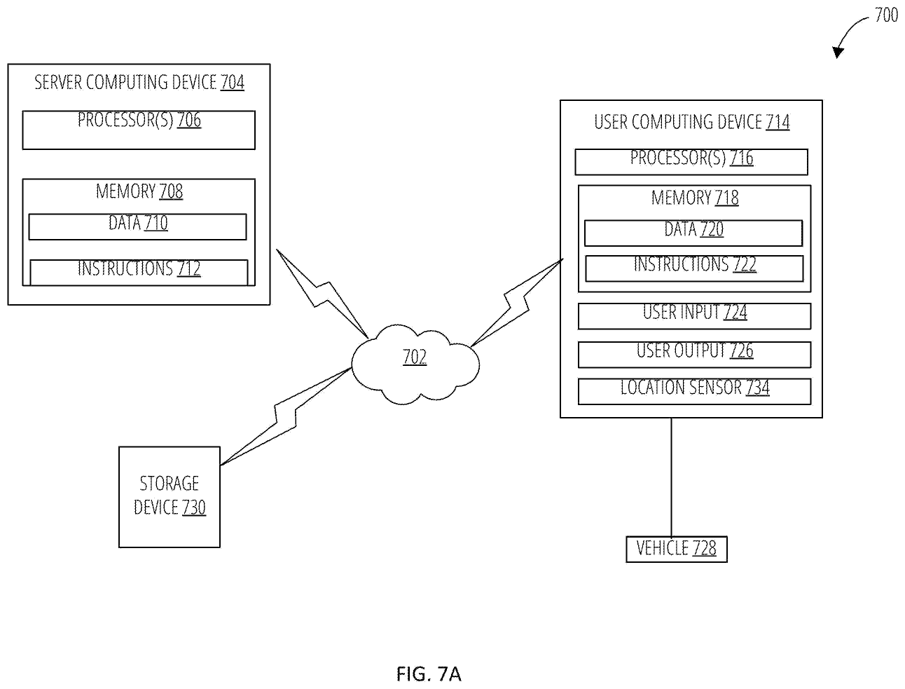

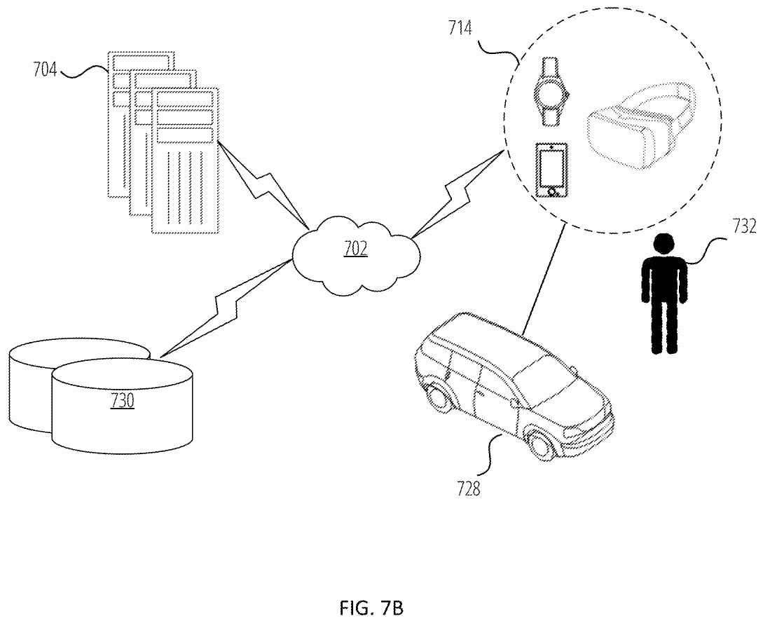

FIG. 7A illustrates an example system in which the features described above may be implemented. It should not be considered limiting the scope of the disclosure or usefulness of the features described herein. In this example, system 700 may include device(s) 714, vehicle(s) 728, server computing device 704, storage device 730, and network 702.

Each of devices 714 may include one or more processor 716, memory 718, data 720 and instructions 722. Each of devices 714 may also include an output 726, user input 724, and location sensor 734. The devices 714 may be any device that includes a location sensor, such as a smartphone, tablet, laptop, smart watch, AR/VR headset, smart helmet, etc., as shown in FIG. 7B.

Memory 718 of devices 714 may store information that is accessible by processor 716. Memory 718 may also include data 720 that can be retrieved, manipulated or stored by the processor 716. The memory 718 may be of any non-transitory type capable of storing information accessible by the processor 716, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 718 may store information that is accessible by the processors 716, including instructions 722 that may be executed by processors 716, and data 720.

Data 720 may be retrieved, stored or modified by processors 716 in accordance with instructions 722. For instance, although the present disclosure is not limited by a particular data structure, the data 720 may be stored in computer registers, in a relational database as a table having a plurality of different fields and records, XML documents, or flat files. The data 720 may also be formatted in a computer-readable format such as, but not limited to, binary values, ASCII or Unicode. By further way of example only, the data 720 may comprise information sufficient to identify the relevant information, such as numbers, descriptive text, proprietary codes, pointers, references to data stored in other memories (including other network locations) or information that is used by a function to calculate the relevant data.

The instructions 722 can be any set of instructions to be executed directly, such as machine code, or indirectly, such as scripts, by the processor 716. In that regard, the terms “instructions,” “application,” “steps,” and “programs” can be used interchangeably herein. The instructions 722 can be stored in object code format for direct processing by the processor 716, or in any other computing device language including scripts or collections of independent source code modules that are interpreted on demand or compiled in advance. Functions, methods and routines of the instructions 722 are explained in more detail below.

The one or more processors 716 may include any conventional processors, such as a commercially available CPU or microprocessor. Alternatively, the processor 716 can be a dedicated component such as an ASIC or other hardware-based processor. Although not necessary, computing devices may include specialized hardware components to perform specific computing functions faster or more efficiently.

Although FIG. 7A functionally illustrates the processor 716, memory 718, and other elements of devices 714 as being within the same respective blocks, it will be understood by those of ordinary skill in the art that the processor 716 or memory 718 may actually include multiple processors or memories that may or may not be stored within the same physical housing. Similarly, the memory 718 may be a hard drive or other storage media located in a housing different from that of the devices 714. Accordingly, references to a processor 716 or device 714 will be understood to include references to a collection of processors or devices or memories that may or may not operate in parallel.

Output 726 may be a display, such as a monitor having a screen, a touch-screen, a projector, or a television. The display of the one or more computing devices may electronically display information to a user via a graphical user interface (“GUI”) or other types of user interfaces. For example, as will be discussed below, the display may electronically display tailored communications based on the user's consumer information.

The user input 724 may be a mouse, keyboard, touch-screen, microphone, or any other type of input. The user input 724 may receive the user's authorization to use the location sensor 792 to obtain location information for the travel metrics. For example, the user can select particular applications for which to allow location services, particular times during which location services can be enabled, or other permissions or limitations for the location services. The user input 724 may receive the user's authorization to use the consumer information to obtain tailored communications from merchants.

According to some examples, the user input 724 may include a camera or image capturing device. The image capturing device may be used to capture, scan, etc. expenditure documentation, such as receipts documenting previous purchases of the user. The expenditure documentation may be used to determine consumer information.

The location sensor 734 may be, for example, a global positioning system (“GPS”) sensor, wireless communications interface, etc. The location sensor 734, when enabled by the user, may provide a rough indication as to the location of the device. According to some examples, when authorized by the user, the location sensors 734 may provide location information indicating relevant destinations, such as establishments where the user has purchased items.

The location information may be stored locally on the device or navigational system, such as part of an application or integrated into a vehicle. In some examples, the location information may be shared to a remote location, such as a remote server or storage system. According to some examples, the location information may be used to identify types of destinations visited and the frequency such that the system does not require or obtain the specific destination location.

The devices 714 can be at various nodes of a network 702 and capable of directly and indirectly communicating with other nodes of network 702. Although a single computing device 714 is depicted in FIG. 7A, it should be appreciated that a typical system can include one or more computing devices 714, with each computing device being at a different node of network 702. The network 702 and intervening nodes described herein can be interconnected using various protocols and systems, such that the network can be part of the Internet, World Wide Web, specific intranets, wide area networks, or local networks. The network 702 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 700 may include one or more server computing devices 704 having a plurality of computing devices, e.g., a load balanced server farm, that exchange information with different nodes of a network for the purpose of receiving, processing and transmitting the data to and from other computing devices. For instance, one or more server computing devices 704 may be a web server that is capable of communicating with the one or more client computing devices via the network. In addition, server computing device 704 may use network 720 to transmit and present information to a user of one of the other computing devices or a passenger of a vehicle. In this regard, vehicles 728 may be considered client computing devices. Server computing device 704 may include one or more processors 706, memory 708, instructions 712, data 710, location sensors, etc. These components operate in the same or similar fashion as those described above with respect to computing devices 714.

As shown in FIG. 7B, each device 714 may be a personal computing device intended for use by a respective user, and have all of the components normally used in connection with a personal computing device including one or more processors (e.g., a central processing unit (CPU)), memory (e.g., RAM and internal hard drives) storing data and instructions, an output, such as a display (e.g., a monitor having a screen, a touch-screen, a projector, a television, or other device such as a smart watch display that is operable to display information), and user input devices (e.g., a mouse, keyboard, touchscreen or microphone). The devices 714 may also include a camera for recording video streams, speakers, a network interface device, and all of the components used for connecting these elements to one another. Devices 714 may be capable of wirelessly exchanging or obtaining data over the network 702.

Although the client computing devices 714 may each comprise a full-sized personal computing device, they may alternatively comprise mobile computing devices capable of wirelessly exchanging data with a server over a network such as the Internet. By way of example only, devices 714 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

User may operate a respective vehicle. The vehicle may include a location sensor. In some examples, the vehicle may include an integrated navigation system. According to some examples, the navigation system may be integrated into a user's respective device. In yet another example, the device or vehicle may execute a mapping application that provides maps or directions, identifies a user's location, etc.

Any use of location information or travel history of a user is authorized by the respective user. For example, the user may provide authorization to an application for determining failure scores by setting certain permissions for the application. The authorization may be for the application to access one or more databases or sub-databases in the memory of the device, vehicle, remote server, etc. According to one example, the user may select specific sub-databases to which the application is granted access. For instance, the user may grant access to the location history database but not the calendar archive database.

Vehicles 728 may include a computing device (not shown). The computing device may include one or more components similar to devices, such as one or more processors, memory, data, instructions, a display, a user input, etc. According to some examples, vehicles 728 may include a perception system for detecting and performing analysis on objects external to the vehicle such as other vehicles, obstacles in the roadway, traffic signals, signs, trees, etc. Additionally, or alternatively, the perception system may determine whether the vehicle is in motion or parked. For example, the perception system may include lasers, sonar, radar, one or more cameras, or any other detection devices which record data which may be processed by a computing device (not shown) within vehicles. In the case where the vehicle is a small passenger vehicle such as a car, the car may include a laser mounted on the roof or other convenient locations as well as other sensors such as cameras, radars, sonars, and additional lasers (not shown).

Storage device 730 may store various types of information. For instance, the storage device 730 may store data or information related to a user's location information, such as the user's travel history, places of interest for the user, relevant destinations, etc. In some examples, storage device 730 may store data or information related to destinations, points of interest (“POI), services, establishments, merchants, or businesses for retrieval in response to identifying an establishment that has one or more previously purchased items available. As used herein, POIs may include any location, or destination, that a user can visit, such as an office building, apartment complex, home address, barber shop, nail salon, big-box store, local hardware store, park, green space, restaurant, theater venue, amusement park, shopping center, etc. In some examples, storage device 730 may store data or information related to items available by one or more merchants. The data or information may include, for example, the type of item, the value or cost of the item, and characteristics of the item, such as the brand, rating, quality, etc.

Storage device 730 may store map data. This map data may include, for instance, locations of POIs, locations of driving lanes, parking lanes, designated parking areas, no parking zones, drop off locations, etc. Map data may also include locations, road names, road configurations, etc.

According to some examples, storage device 730 may store data or information related to a user's location information after receiving authorization from the user. The authorization may be, for example, provided by setting permissions for the system to access location information and travel history. For example, a user may be provided with controls allowing the user to make an election as to both if and when systems, programs, or features described herein may enable collection of location information, and if the user is sent content or communications from a server. In addition, certain data may be treated in one or more ways before it is stored or used, so that personally identifiable information is removed. The user may have control over what information is collected about the user, how that information is used, and what information is provided to the user. The user's location information or travel history may be used to identify, or determine, a user's starting location, merchant location of a user's previous purchase, etc.

While FIGS. 7A and 7B illustrate a single user 732 and their respective device(s) device 714 and vehicle 728, it should be understood that there may be multiple users and their respective devices and vehicles. The location information and travel history of each user may be used to determine a respective user's travel history. According to some examples, the location information and travel history of each user may be used to determine a current location of the user, a location of an establishment where the user previously purchased items, a common starting location for a user's trips, etc.

Each respective user provides authorization for an application to access their location information and travel history. The user may set permissions for the application to indicate what location information and travel history the application may access. The location information may be stored locally on the user device. In some examples, the location information from the user device(s) and/or navigational applications may be shared with and, therefore, stored by one or more servers. In yet another example, the location information may be captured and stored by navigational applications. The location information and travel history may only be shared with and stored by servers after a user authorizes the sharing of location information and travel history.

Each respective user provides authorization for the application to access or receive consumer information. The user may set permission for the application to indicate what consumer information the application may access. The consumer information may be stored locally on the user device. In some examples, the consumer information may be shared with and, therefore, stored by one or more servers. The consumer information may only be shared with and stored by servers after a user authorizes the sharing of location information and travel history.

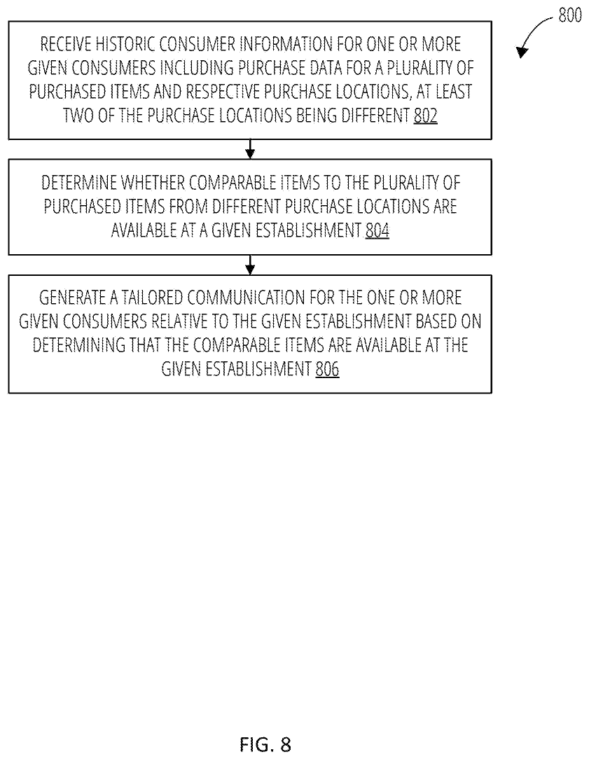

FIG. 8 illustrates an example method for generating a tailored communication. The following operations do not have to be performed in the precise order described below. Rather, various operations can be handled in a different order or simultaneously, and operations may be added or omitted.

In block 802, historic consumer information for one or more given users may be received by the system. The historic consumer information may include purchase data for a plurality of purchased items and respective purchase locations. According to some examples, at least two of the purchase locations are different locations. For example, the user may have purchased items from Drug Store A and Sports Store B. Receiving the historic consumer information may include receiving proof of purchase documents, such as a digital receipt or a digital photo of a receipt. Historic consumer information may be determined based on parsed text from the proof of purchase documents.

In block 804, the system may determine whether comparable items to the plurality of purchased items from different purchase locations are available at a given establishment. For example, the system may identify comparable items to the plurality of purchased items by identifying at least one characteristic of a purchased item. The characteristic may include, for example, a type, quality, brand, value, rating, etc. of the item. A comparable item may have at least one characteristic of the purchased item. For example, if the previously purchased item is hair gel, the comparable item may also be hair gel. The other characteristics, such as quality, brand, value, rating, etc., may be the same or substantially similar. For example, if the previous purchased hair gel is salon quality, the comparable item may also be salon quality. According to some examples, at least one of the comparable items may be the same as the purchased items.

In block 806, a tailored communication may be generated for the one or more given users relative to the given establishment based on determining that the comparable items are available at the given establishment and traveling to the given establishment, rather than the respective purchase locations, would improve a value of at least one travel metric. For example, the tailored communication may provide an indication that the given establishment has the comparable items available. In some examples, the tailored communication may include navigation direction to the given establishment. Additionally, or alternatively, the tailored communication may provide an indication of improved metrics, such as improved travel metrics, if the user were to visit the given establishment.

The improved travel metrics may be determined by comparing the travel metrics for a first route to the respective purchase locations to the travel metrics for a second route to the given establishment. The travel metrics may be determined based on a predefined starting location, such as the user's home address or a location identified based on the user's travel history. The travel metrics may include, for example, a total mileage, a total amount of driving time, a carbon footprint associated with the route, fuel efficiency, total number of stops, etc. According to some examples, a value of the first travel metrics associated with the plurality of purchased items at the respective purchase location may be determined. For example, the first route to the respective purchase locations may be determined and the first route may be used to determine the value of the first travel metrics. A value of the second travel metrics associated with purchasing the comparable items at the given establishment may be determined. For example, the second route to the given establishment may be determined and the second route may be used to determine the value of the second travel metrics. The values of the first and second travel metrics may be compared to determine whether the value of the second travel metrics is improved as compared to the value of the first travel metrics. An improvement in the value of the travel metrics may include, for example, increased fuel efficiency, decreased driving time, decreased mileage, decreased carbon footprint, decreased travel expenses, fewer stops, etc. The tailored communication may be generated in response to determining that the value of the second travel metrics is improved.

According to some examples, the historical consumer information may be used to determine a cost of living. For example, a first estimated cost of living associated with the plurality of purchased items at the respective purchase locations may be determined. A score representing an aggregated cost of living for a geographic area including the respective purchase locations may be provided for output. In some examples, a second cost of living associated with purchasing the comparable items at the given establishment may be determined. The first estimated cost of living and the second cost of living may be compared to determine whether the second cost of living is improved as compared to the first cost of living. According to some examples, the tailored communication may include an indication of an improved cost of living.

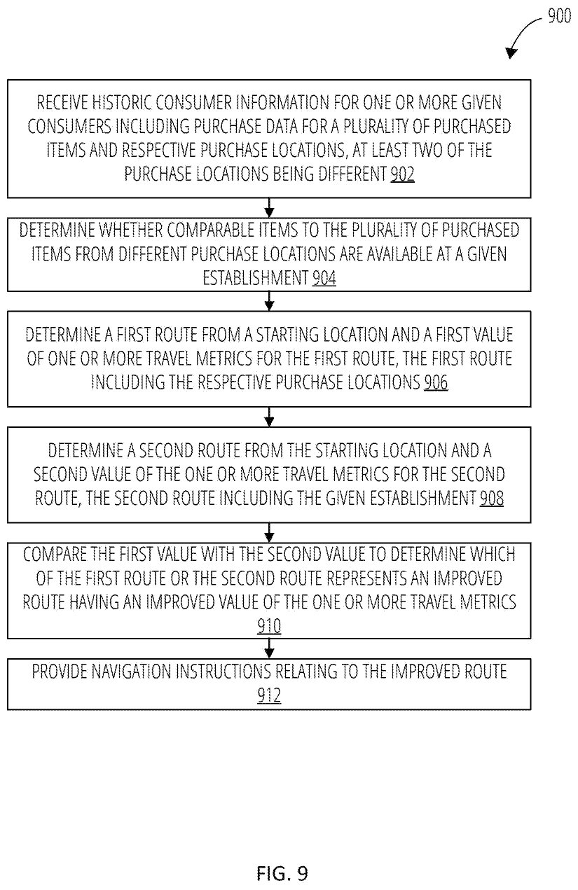

FIG. 9 illustrates an example method for providing navigation instructions for an improved route. The following operations do not have to be performed in the precise order described below. Rather, various operations can be handled in a different order or simultaneously, and operations may be added or omitted.

In block 902, similar to block 802, historic consumer information for one or more given users may be received by the system. The historic consumer information may include purchase data for a plurality of purchased items and respective purchase locations. Receiving the historic consumer information may include receiving proof of purchase documents, such as a digital receipt or a digital photo of a receipt. Historic consumer information may be determined based on parsed text from the proof of purchase documents.

In block 904, similar to block 804, the system may determine whether comparable items to the plurality of purchased items from different purchase locations are available at a given establishment. For example, the system may identify comparable items to the plurality of purchased items by identifying at least one characteristic of a purchased item. The characteristic may include, for example, a type, quality, brand, value, rating, etc. of the item. A comparable item may have at least one characteristic of the purchased item. According to some examples, at least one of the comparable items may be the same as the purchased items.

In block 906, a first route from a starting location and a first value of one or more travel metrics for the first route may be determined. The first route may include the respective purchase locations of the previously purchased items. The travel metrics may include, for example, distance traveled, time of travel, driving expenses, carbon footprint, fuel efficiency, number of stops, etc.

In block 908, a second route from the starting location and a second value of the one or more travel metrics for the second route may be determined. The second route may include the given establishment. The second route may start from the same starting location of the first route.

In block 910, the first value may be compared with the second value to determine which of the first route or the second route represents an improved route having an improved value of the one or more travel metrics. Improved value of the travel metrics may include, for example, increased fuel efficiency, decreased driving time, decreased mileage, decreased carbon footprint, decreased travel expenses, fewer number of stops, etc.

In block 912, navigation instructions relating to the improved route may be provided. The navigation instructions may be provided, for example, as a tailored communication. In some examples, the navigation instructions may be provided with an indication identifying the given establishment. According to some examples, the navigation instructions may be provided with an indication of the improved value of the one or more travel metrics.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors, historic consumer information for one or more given consumers including purchase data for a plurality of purchased items and respective purchase locations, at least two of the purchase locations being different;
determining, by the one or more processors, first travel metrics associated with the plurality of purchased items at the respective purchase locations;
determining, by the one or more processors, whether comparable items to the plurality of purchased items from different purchase locations are available at a given establishment;
determining, by the one or more processors, second travels metrics associated with purchasing the comparable items at the given establishment;
determining, by the one or more processors, that the second travel metrics are improved as compared to the first travel metrics; and
in response to determining that the second travel metrics are improved, generating, by the one or more processors, a tailored communication for the one or more given consumers relative to the given establishment based on determining that the comparable items are available at the given establishment.

2. The method of claim 1, wherein the first and second travel metrics include at least one of a total mileage, a total amount of driving time, a carbon footprint, a driving expense, fuel efficiency, or a total number of stops for a trip.

3. The method of claim 1, further comprising identifying, by the one or more processors, the comparable items, wherein identifying comparable products includes:
identifying, by the one or more processors, at least one characteristic of a purchased item; and
identifying, by the one or more processors, a comparable item having the at least one characteristic of the purchased item.

4. The method of claim 3, wherein the at least one characteristic includes a type, quality, brand, value, or rating.

5. The method of claim 1, wherein:
receiving the historic consumer information includes receiving, by the one or more processors, one or more proof of purchase documents, and
the one or more proof of purchase documents includes a digital receipt or a digital photo of a receipt.

6. The method claim 1, further comprising determining, by the one or more processors, a first estimated cost of living associated with the plurality of purchased items at the respective purchase locations.

7. The method of claim 6, further comprising providing for output, by the one or more processors, a score representing an aggregated cost of living for a geographic area including the respective purchase locations.

8. The method of claim 7, further comprising:
determining, by the one or more processors, a second cost of living associated with purchasing the comparable items at the given establishment; and
determining, by the one or more processors, that the second cost of living is improved as compared to the first cost of living,
wherein the tailored communication further includes an indication of an improved cost of living.

9. The method of claim 1, wherein the comparable items to the plurality of purchased items includes:
at least one item being the same as at least one of the plurality of purchased items,
at least one item being having a similar composition but a different brand of at least one of the plurality of purchased items, or
at least one item being a complementary item to at least one of the plurality of purchased items.

10. The method of claim 1, wherein the given establishment is an online retailer.

11. The method of claim 1, wherein the given establishment is identified using a machine learning model.

12. A system, comprising:
one or more processors, the one or more processors configured to:
receive historic consumer information for one or more given consumers including purchase data for a plurality of purchased items and respective purchase locations, at least two of the purchase locations being different;
determine first travel metrics associated with the plurality of purchased items at the respective purchase locations;
determine whether comparable items to the plurality of purchased items from different purchase locations are available at a given establishment;
determine second travels metrics associated with purchasing the comparable items at the given establishment;
determine that the second travel metrics are improved as compared to the first travel metrics; and
in response to determining that the second travel metrics are improved, generate a tailored communication for the one or more given consumers relative to the given establishment based on determining that the comparable items are available at the given establishment.

13. The system of claim 12, wherein the first and second travel metrics include at least one of a total mileage, a total amount of driving time, a carbon footprint, a driving expense, fuel efficiency, or a total number of stops for a trip.

14. The system of claim 12, wherein the one or more processors are further configured to:
identify the comparable items, wherein identifying comparable products includes:
identify at least one characteristic of a purchased item; and
identify a comparable item having the at least one characteristic of the purchased item.

15. The system of claim 14, wherein the at least one characteristic includes a type, quality, brand, value, or rating.

16. The system of claim 12, wherein:
when receiving the historic consumer information, the one or more processors are further configured to receive one or more proof of purchase documents, and
the one or more proof of purchase documents includes a digital receipt or a digital photo of a receipt.

17. The system of any one of claim 12, wherein the comparable items to the plurality of purchased items includes:
at least one item being the same as at least one of the plurality of purchased items,
at least one item being having a similar composition but a different brand of at least one of the plurality of purchased items, or
at least one item being a complementary item to at least one of the plurality of purchased items.

18. The system of claim 12, wherein the given establishment is an online retailer.

19. The system of claim 12, wherein the given establishment is identified using a machine learning model.

20. A computer-readable storage medium, the computer-readable storage medium including instructions that when executed by one or more processors, cause the one or more processors to:
receive historic consumer information for one or more given consumers including purchase data for a plurality of purchased items and respective purchase locations, at least two of the purchase locations being different;
determine first travel metrics associated with the plurality of purchased items at the respective purchase locations;
determine whether comparable items to the plurality of purchased items from different purchase locations are available at a given establishment;
determine second travels metrics associated with purchasing the comparable items at the given establishment;
determine that the second travel metrics are improved as compared to the first travel metrics; and
in response to determining that the second travel metrics are improved, generate a tailored communication for the one or more given consumers relative to the given establishment based on determining that the comparable items are available at the given establishment.
